(19) United States
(12) Patent Application Publication
(10) Pub. No.: US 2005/0055205 A1
(43) Pub. Date: Mar. 10, 2005

(54) Intelligent user adaptation in dialog systems

(76) Inventors: Thomas Jersak, Nuertingen (DE); Susanne Kronenberg, Ulm (DE); Alexandros Philopoulos, Ulm (DE)

Correspondence Address: PENDORF & CUTLIFF, 5111 MEMORIAL HIGHWAY, TAMPA, FL, 33634-7356, US

(21) Appl. No.: 10/927,817

(22) Filed: Aug. 27, 2004

(30) Foreign Application Priority Data
Sep. 5, 2003 (DE) 103 41 305.7

(51) Int. Cl. G10L 15/00

(52) U.S. Cl. 704/233

(57) ABSTRACT

In a process for operating a speech dialog system, which adapts its to the speech quality of different speakers, the speech recognizer estimates the probability of a correct recognition of the user response or expression, in that it consults for estimation a confidence gage by means of which the words or phrases potentially contained in the speech response or expression are assigned a confidence value. One of the particularly preferred solutions of the inventive task are comprised in that for those speakers which are difficult for the speech dialog system to understand, it accepts in certain cases repetitions of the same user responses which, by themselves, would not be acceptable. A further advantageous solution is comprised therein, that the confidence threshold is selected depending upon the actual current dialog step. Thereby the speech dialog system adapts itself to the system user depending upon the actual dialog stage and makes possible that those responses, which fit without problem into the actual dialog flow, are accepted more rapidly even in the case of speakers which are difficult to understand. Alternatively to this, there is provided a solution, at least in those cases, in which it has not been concluded that a correct recognition has been made, to store this at least temporarily in a storage medium. Thereby the system behavior adapts itself dynamically with a system user, in that it observes the speech comprehensibility of the system user, so that user responses are accepted, which lie below the actual confidence threshold value to be observed.

### BACKGROUND OF THE INVENTION

1. Field of the Invention

The invention concerns processes for operating a speech dialog system that adapts itself to the speech quality of different speakers according to the precharacterizing portion of patent claims 1, 3 and 4.

It is common for modern technical equipment to be linked to a speech dialog system, by means of which the technical equipment can be operated by the user. Thus it is known to operate navigation and audio systems in motor vehicles using a speech interface coupled to a speech dialog system. Likewise, automatic speech operated information and reservation systems are known, in which a user can request and arrange for desired services (make reservations or obtain schedule information). In the framework of a dialog with the system user, the speech dialog system initiates requests for spoken responses, whereupon the system then waits for the user's responses. In order in certain cases to understand the responses of the user, a speech recognizer is activated. In those situations, in which no user response occurs, the speech recognizer is terminated after a certain amount of time (final-timeout) and the speech dialog system reacts with a renewed interrogatory or request for spoken response.

2. Related Art of the Invention

From EP 0 651 371 A2 a speech dialog system of this type is known, which makes it possible to adapt the dialog depending upon the comprehensibility of the speech of a user.

For this, the speech recognizer associated with the speech dialog estimates the probability of a correct recognition of the user's response to a request for a vocal response. A confidence value is used in the estimation, which is associated with words or, as the case may be, phrases potentially contained in the spoken response. If the confidence value of a potentially recognized word or, as the case may be, phrase exceeds a certain confidence threshold, then it is assumed with high probability that the word or the phrase were correctly recognized, so that the dialog can proceed to the next dialog step. If the confidence value lies below the confidence threshold, then the speech dialog is adapted to the system user to the extent, that the he is informed of the potentially recognized word or, as the case may be, phrase, and he is requested to either confirm the correctness of this recognition or to identify the word or, as the case may be, phrase which was falsely recognized. If the word or, as the case may be, phrase was found to have been falsely identified, then the recognition result is discarded and the interrogation is repeated.

In the case of system users which have a speech manner which is easy for the dialog system to understand, the confidence values generated by the speech recognizer almost always lie above the confidence threshold. Thereby the speech dialog is adapted to this system user to the extent that such users can navigate through the dialog without follow-up questioning, and therewith can rapidly reach the goal of the dialog. On the other hand, it is made possible that the speech dialog system flexibly adapts also to system users with difficult-to-understand manners of speech, without excluding these from the dialog. This occurs by having the individual potentially recognized speech artifacts, which exhibit only a low confidence value, verified using follow-up questions. The speech dialog system also adapts itself therewith flexibly to the situations in which easily understandable system users communicate with a system but in an environment with strong background noises.

A free speech device, which in similar manner adapts to easily understandable and poorly understandable speakers, is described in U.S. Pat. No. 5,305,244 A1. Here also a speech recognizer concludes on the basis of a confidence value, by means of which a confidence degree of a potentially recognized word or, as the case may be, phase is determined, as to the correctness of recognition by comparison with a confidence threshold. If the confidence value is below the confidence threshold value, then the system user is informed of the potential recognized word or, as the case may be, phrase, and he is requested to confirm the correctness of the recognition or, in certain cases, to identify when the word or, as the case may be, phrase is falsely recognized. In the case that the correctness of the recognition is confirmed, the classifier within the speech recognizer is modified to the extent that it is trained with regard to the word or, as the case may be, phrase determined to be correctly identified with the actual signal data received by the speech interface. In this manner the classification contained in the speech recognizer and the recognition algorithm is adapted to the respective system user. By the adaptive modification of the recognition algorithm the recognition capacity in regard to the then existing speaker is improved; however, the process is suitable for use only when operating with this single user, and encounters problems when used by multiple speech system users having varying speech quality.

The speech interrogation produced by a dialog system is as a rule so designed, that even users who are not experienced with the system obtain sufficient instruction as to which type of response to the interrogation the system expects. This leads however frequently thereto, that experienced system users are irritated by the expansiveness of the interrogation, since they already know at the beginning of the interrogation, which responses to the interrogatories the system is expecting to be used. For this type of user the flow of the dialog would be too slow, thus advanced speech dialog systems offer the possibility of a so-called “barge-in”. Barge-in allows the system user to interrupt the speech interrogation of a speech dialog system by a user's verbal input. In the case of such a verbal input, this could be a premature or advanced input of an expression expected by the system, or however could be other inputs influencing the speech dialog. By these verbal inputs the continuation of the speech interrogation is interrupted. This provides the benefit of a more efficient interaction with the system, in that the speech dialog is thereby accelerated when the system user can interrupt and stop the speech interrogation. It can however be problematic herein, when the speech recognizer of the speech dialog system in certain conditions falsely interprets the vocalizations of the system user. In this case, on the one hand the speech interrogation is interrupted, the dialog however can no longer be intelligently continued after the apparent expression provided by the system user.

In order to avoid the undesired dialog interruption as a result of false interpretation of user expressions, it is conventional for the speech recognizer associated with the speech dialog system to evaluate the expression of a system user as to the likelihood of a correct recognition of the user's expression. This occurs in that it draws upon a confidence gauge for estimation, by means of which the potentially contained word or, as the case may be, phrase contained in the speech expression is associated with a confidence value. On the basis of this confidence value then a conclusion is made as to a correct recognition, if this exceeds a certain confidence threshold. If this is the case, then this output of the speech interrogation is broken off and the dialog is continued on the basis of the expressions of the system user. If the confidence value of a potentially recognized word is below the confidence threshold value, then the speech dialog system does not react to the expression of the user and continues with the output of this speech interrogation. In this manner the speech dialog system adapts its conduct or performance to speakers with different speech quality, in that it accepts barge-in from easily understood speakers, however in the framework of the barge-in dismisses expressions of poorly understood speakers. A dismissal of the expressions of the system user is herein relatively unproblematic, since it is within the familiar user behavior, to repeat a previously provided response or expression in the case that no reaction was made thereto by the system. Where this is however problematic is in the interaction of the dialog system with poorly understood speakers. Herein it can occur, that the same expression is repeated multiple times, and each time the confidence value associated with this expression is below the confidence threshold value. This then results in the user not being able to exercise influence on the speech dialog via the barge-in.

### SUMMARY OF THE INVENTION

It is thus the task of the invention to find a process for operating a speech dialog system that adapts itself to the speech quality of various speakers, that also allows poorly understood system users to exercise influence on the speech dialog by their response to a speech interrogations or, as the case may be, there response to interruptions, without the speech dialog being unable to be continued in the case of misunderstanding of the responses of the user.

The task is solved by a process having the characteristics of patent claims 1, 3 and 4. Advantageous embodiments and further developments of the invention are set forth in the dependent claims.

### DETAILED DESCRIPTION OF THE INVENTION

In the process for operating a speech dialog system, that adapts itself the speech quality of different speakers, the responses of a system user are supplied via a speech interface to a speech recognizer associated with the speech dialog system. Thereupon the speech recognizer estimates the probability of correct recognition of the user response, in that for this estimation it draws upon a confidence gauge, by means of which the word or, as the case may be, phrase potentially contained in the verbal response is assigned a confidence value. Therein then, a conclusion is made as to correct recognition of that word or, as the case may be, that phrase which exhibits a greatest confidence value, if this confidence value exceeds a certain confidence threshold value. Depending upon whether a conclusion was as to whether or not a correct recognition had been made, the speech dialog system then adapts the sequence of progression of the speech dialog.

As a rule a conventional, frequently also application-specific, confidence threshold is determined experimentally, and is in general so selected, that the majority of the responses by system users which are easy for the speech dialog system to understand are correctly recognized by the speech recognizer of the system. From the state of the art, a large number of confidence measurements suitable for such a speech dialog system are known. In this way a suitable confidence gauge could be defined thereby, that a differential is formed between the recognition probability of a word or phrase recognized by the speech recognizer and the word or, as the case may be, phrase having the next lower probability of recognition. The confidence value assigned to the word or, as the case may be, phrase then corresponds to this differential.

One of the particularly preferred solutions of the problem addressed according to the present invention is thus comprised therein, that at least in those cases, in which a conclusion was not made as to a correct recognition, the potentially recognized words or, as the case may be, phrases are temporarily stored in a storage medium. If then the speech recognizer in the subsequent recognition process decides anew that a correct recognition had been made, then at least the words or, as the case may be, phrases stored most recently in the storage medium are compared with the words or phrases newly potentially recognized by the speech recognizer. The speech recognizer will then conclude in accordance with the invention that there has been a correct recognition of a word or, as the case may be, a phrase if in the framework of the comparison this word or, as the case may be, phrase is identified both in the stored words or, as the case may be, phrases as well as in the new potential words or, as the case may be, phrases.

By this advantageous design of the invention, speakers who are difficult for the speech dialog system to understand are supported therein in that in certain cases repetitions of the same user expression are accepted, even when the confidence value assigned to this expression lies below the actual confidence value being observed.

In order to minimize the required computation power and the required memory space it is advantageous when in the framework of the comparison of the new potential recognized words or, as the case may be, phrases, only those stored words or, as the case may be, phrases of the preceding response are consulted or drawn upon for comparison. At the same time however applications are also conceivable, in particular in the case of the field of security technology, in which the new words or, as the case may be, phrases are compared with multiple past expressions and a conclusion is reached as to correct recognition only when, after multiple expressions, the same word or, as the case may be, the same phrase, can be identified.

The computation and memory outlay can be further optimized when a further threshold value is defined, with which the confidence value associated with the potentially recognized words or, as the case may be, phrases are compared. If the associated confidence value lies below this additional threshold value, then this potentially recognized word is not stored in the storage unit for the purpose of future comparison.

A further advantageous solution of the inventive task is comprised therein, that the confidence threshold value is selected depending upon the actual current dialog step. This is based on the fact that the user of the speech dialog system can respond in different manners to the speech interrogations of the system. Thus he can execute or make a response, which corresponds to the actual dialog step, so that the dialog can be continued in the conventional intended manner. On the other hand it is however also often possible for the system user, using a specified or targeted expression, to steer the dialog in a different than the conventional direction; for example, in that short-cuts can be provided, or that the flow of the dialog is intentionally switched over to a different dialog (change of the flow of dialog). If the response expressed by the user is on the projected path through the dialog, then the speech recognizer preferably lowers the normal confidence threshold value, such that it also reaches a conclusion as to a recognized word or, as the case may be, phrase even if this attains a lower than normal confidence value. If the system user however, by his response, changes the branch or flow of the dialog, then it must be checked by the speech recognizer, whether the word or, as the case may be, phrase, which it has determined to have correctly recognized, in fact represents the actual intention of the system user. Thus, in such a situation the confidence threshold is not lowered. It is even conceivable, that in such a situation in which deviation is made from the conventional dialog flow, the normal confidence threshold is raised.

By this advantageous solution of the inventive task it is accomplished that the speech dialog system adapts itself to the system user depending upon the actual present state of the dialog and therewith makes it possible that those expressions which, without problem, fit into the actual flow of dialog are more readily or rapidly accepted even in the case of poorly understood speakers, than would be the case for the dialog flow following different responses or expressions.

Alternatively thereto, the inventive task can be advantageously solved thereby, that at least in those cases, in which no conclusion has been made as to a correct recognition, the responses are stored at least partially in a memory unit or storage medium. This approach to the solution envisions a lowering of the normal confidence threshold if the expressions of a system user, for which no conclusion was made as to recognition, exceeds a predetermined number relative to the total number of expressions or responses. Thus it would be conceivable that, for example, in the case that at least 80% of the maximum responses of the system user achieve a confidence value which is below the confidence threshold, the confidence threshold value is lowered. For this it would, on the one hand, be conceivable to lower the confidence threshold value to the extent that all of the hitherto maximum achieved confidence values come to lie above this threshold value. In order to ensure a certain recognition confidence it is, however, better to lower the confidence threshold value only to the extent that only a certain number of the previous maximum achieved confidence values exceed the threshold value. If this value is set at for example that 50% of the responses determined recently to be not recognized exceed the threshold value, then approximately a doubling of the frequency of recognition can be achieved by the speech recognizer. In this manner the acceptance threshold of the speech dialog system is set to be lower, and the speech manner or conduct of the user is adapted to.

In contrast, in advantageous manner, a security type system for example can be improved in that, in the case that the maximal confidence values associated with the expressions of the system user significantly or clearly exceed the normal confidence threshold value, the threshold is raised.

As a rule, the user will not notice this increase in the confidence threshold value, since his responses or expressions normally continue to achieve these superior confidence values. In this manner the recognition confidence is raised or elevated without substantial reduction in operating convenience or comfort.

The advantage of all the above described embodiments of the invention are comprised therein, that the system behavior of the speech dialog system dynamically adapts to the system user, in that it takes into consideration the understandability of the speech and partially also the actual current dialog step. Speakers who are difficult for the speech dialog system to understand are supported in that in certain cases repetitions of the same response or expression are deemed accepted, even when the confidence value associated with this response is below the confidence threshold value to be observed. On the other hand, the system is partially also capable of adapting itself to well understood speakers by increasing the confidence threshold value, such that the recognition reliability can be elevated without substantial forfeiture in speech comfort.

In particularly preferred manner the above described processes can be improved if, as the starting value for the confidence threshold value, at the beginning of the process a threshold value which has already previously been matched to the actual user is employed. For this it would be conceivable that the system user identifies himself at the beginning of the speech dialog, for example upon activation of the speech dialog system, explicitly or however that the speech dialog system includes a personal identification device or is in communication with such a device, in order to automatically recognize the system user. The presetting of the confidence value by direct input in the speech dialog system (in particular haptically, or by keyboard, or vocally via a microphone) occur or, however, could occur automatically by reading from a table previously recorded in memory, in which, for the individual users, customized confidence threshold values are recorded. If a particular user is not already registered in such a table, the dialog system could adjust the confidence threshold value, for example, to a standardized threshold value, and could subsequently make an entry into the table for any subsequent dialog.

The inventive process can be advantageously employed not only in those phases of the speech dialog system within which the speech dialog system expects a response or expression fro the system user to a speech interrogatory, but rather is suited likewise for improvement of the barge-in ability of the system. By the inventive adaptation of the speech dialog system to various speakers, it frequently becomes possible, even with the more difficult to understand system users (speakers), to intentionally interrupt the speech interrogation of the speech dialog system and thereby to accelerate the dialog. The system thus exhibits also in those cases, in which it experiences difficulties in understanding (poorly understood speakers), an elevated ability to cooperate.

1. A process for operating a speech dialog system, that adapts to the speech quality of different speakers,
in which the responses of a system user are supplied via a speech interface to a speech recognizer associated with the speech dialog system,
whereupon the speech recognizer estimates the likelihood of a correct recognition of the user response,
in that, for estimation, it consults a confidence gage, via which the words or phrases potentially contained in the speech response are assigned a confidence value,
and in that a conclusion is reached as to the correctness of the recognition of those words or, as the case may be, those phrases, which are associated with the greatest confidence values, when these confidence values exceed a predetermined confidence threshold value,
and wherein a subsequent sequence of the speech dialog is adapted to the system user depending upon whether or not a conclusion had been reached that the recognition was correct,
wherein at least in the case, in which no conclusion had been made as to a correct recognition, the potentially recognized words or, as the case may be, phrases are stored temporarily in a storage medium,
wherein when the speech recognizer, during subsequent recognition processes, again does not come to a conclusion of a correct recognition, then at least the most recent words or, as the case may be, phrases stored in the storage medium are compared with the new words or phrases potentially recognized by the speech recognizer, and
wherein the speech recognizer then makes a conclusion as to the correct recognition of a word or, as the case may be, phrase, if in the framework of the comparison these words or, as the case may be, these phrases, are identified both in the stored words or, as the case may be, phrases, as well in the new potentially recognized words or, as the case may be, phrases.

2. A process according to claim 1, wherein for comparison with the new potentially recognized words or, as the case may be, phrases, only the potentially recognized words or, as the case may be, phrases of the most recent expression or response of the system user are consulted.

3. A process for operating a speech dialog system, that adapts to the speech quality of different speakers,
in which the responses of a system user are supplied via a speech interface to a speech recognizer associated with the speech dialog system,
whereupon the speech recognizer estimates the likelihood of a correct recognition of the user response,
in that, for estimation, it consults a confidence gage, via which the words or phrases potentially contained in the speech response are assigned a confidence value,
and in that a conclusion is reached as to the correctness of the recognition of those words or, as the case may be, those phrases, which are associated with the greatest confidence values, when these confidence values exceed a predetermined confidence threshold value,
and wherein a subsequent sequence of the speech dialog is adapted to the system user depending upon whether or not a conclusion had been reached that the recognition was correct,
wherein the confidence threshold value is selected depending upon the actual current dialog step,
wherein then, if the user response lies upon the projected path through the dialog, the normal confidence threshold value is lowered, so that the speech recognizer makes a conclusion as to a recognized word or, as the case may be, phrase, if this obtains a lower confidence value then was conventionally previously necessary.

4. A process for operating a speech dialog system, that adapts to the speech quality of different speakers,
in which the responses of a system user are supplied via a speech interface to a speech recognizer associated with the speech dialog system,
whereupon the speech recognizer estimates the likelihood of a correct recognition of the user response,
in that, for estimation, it consults a confidence gage, via which the words or phrases potentially contained in the speech response are assigned a confidence value,
and in that a conclusion is reached as to the correctness of the recognition of those words or, as the case may be, those phrases, which are associated with the greatest confidence values, when these confidence values exceed a predetermined confidence threshold value,
and wherein a subsequent sequence of the speech dialog is adapted to the system user depending upon whether or not a conclusion had been reached that the recognition was correct,
wherein at least in those cases, in which a conclusion has not been made as to a correct recognition, the word or phrase is at least temporarily stored in a storage medium, and
wherein the confidence threshold is lowered, if the responses of the system user, for which a correct recognition has not been concluded or determined, exceeds a predetermined proportion relative to the total number of responses, or
that wherein the confidence threshold value is raised, if the responses of a system user, for which correct recognition has been concluded, always lies significantly above the confidence threshold value.

5. A process according to claim 4, wherein the confidence threshold value is additionally selected depending upon the actual dialog step,
wherein if the user response lies upon the projected path through the dialog, the normal confidence threshold value is lowered, so that the speech recognizer makes a conclusion as to a recognized word or, as the case may be, phrase, even if this obtains a lower confidence value than was conventionally necessary therefore.

6. A process according to claim 4, wherein at the beginning of the process the confidence threshold is adapted specifically to different users.

7. A process according to claim 1, wherein at the beginning of the process the confidence threshold is adapted specifically to different users.

8. A process according to claim 2, wherein at the beginning of the process the confidence threshold is adapted specifically to different users.

9. A process according to claim 3, wherein at the beginning of the process the confidence threshold is adapted specifically to different users.

10. A process according to claim 5, wherein at the beginning of the process the confidence threshold is adapted specifically to different users.
